(19) United States
(12) Patent Application Publication
(10) Pub. No.: US 2014/0372674 A1
(43) Pub. Date: Dec. 18, 2014

(54) MEMORY CONTROLLER, OPERATING METHOD, AND MEMORY SYSTEM INCLUDING SAME

(71) Applicant: SAMSUNG ELECTRONICS CO., LTD., Suwon-si (KR)

(72) Inventors: MOO SUNG KIM, YONGIN-SI (KR); YOUNG JO PARK, YONGIN-SI (KR)

(73) Assignee: SAMSUNG ELECTRONICS CO., LTD., Suwon-si (KR)

(21) Appl. No.: 14/284,415

(22) Filed: May 22, 2014

(30) Foreign Application Priority Data
Jun. 17, 2013 (KR) 10-2013-0068835

(51) Int. Cl. G06F 12/02

(52) U.S. Cl. CPC G06F 12/0246; G06F 2212/7207
USPC 711/103

(57) ABSTRACT

A method of operating a memory controller includes determining an access property for a target address region and controlling a threshold voltage distribution of memory cells included in the target address region according to the determined access property.

### CROSS-REFERENCE TO RELATED APPLICATIONS

This application claims priority under 35 U.S.C. §119(a) from Korean Patent Application No. 10-2013-0068835 filed on Jun. 17, 2013, the subject matter of which is hereby incorporated by reference.

### BACKGROUND

The inventive concept relates generally to methods of operating a memory controller, and more particularly to methods of controlling a threshold voltage distribution of memory cells according to an access property of an address region. The inventive concept also relates to memory controllers operating in this manner, and memory systems incorporating such memory controllers.

Flash memory is a particular type of non-volatile memory that is widely used in contemporary digital devices and consumer electronics. Flash memory is characterized by large data storage capacity, non-volatile data storage, and relatively fast data access speed. Flash memory includes NAND type flash memory and NOR type flash memory. Flash memory cells may be single-level memory cells (SLC) capable of storing 1 bit, and multi-level memory cells (MLC) capable of storing 2 or more bits.

Data is stored in respective flash memory cells in accordance with an erase state and one or more program states, each being indicated by a particular threshold voltage distribution of the flash memory cell. That is, the threshold voltage distribution of a flash memory cell may be set (or reset) by a competent program operation, and the accuracy with which a flash memory device and/or memory controller in a memory system may program the threshold voltage of constituent flash memory cells in relation to a defined set of threshold voltage distributions largely defines the data reliability of the flash memory device and/or memory system.

### SUMMARY

An embodiment of the present invention is directed to a method of determining an access property for a target address region of a nonvolatile memory device, and controlling a threshold voltage distribution of memory cells in the target address region in accordance with the determined access property.

Another embodiment of the present invention is directed to a memory controller comprising; an access property determination module that determines an access property for a target address region of a nonvolatile memory device, and an operation condition control module that controls a threshold voltage distribution of memory cells in the target address region in accordance with the determined access property.

Another embodiment of the present invention is directed to a memory system comprising; a memory controller, and a flash memory device, wherein the memory controller comprises an access property determination module that determines an access property for a target address region of a nonvolatile memory device, and an operation condition control module that controls a threshold voltage distribution of memory cells in the target address region in accordance with the determined access property.

### BRIEF DESCRIPTION OF THE DRAWINGS

These and/or other aspects and advantages of the inventive concept will become apparent and more readily appreciated from the following description of the embodiments taken in conjunction with the accompanying drawings of which:

FIG. 1 is a block diagram of an electronic system according to certain embodiments of the inventive concept;

FIG. 2 is a block diagram further illustrating the memory controller 100 of FIG. 1;

FIG. 3 is a block diagram illustrating one possible hardware/software structure for the electronic system of FIG. 1;

FIGS. 4 and 5 are respective flowcharts summarizing methods of operating a memory controller according to embodiments of the inventive concept;

FIG. 6 is a conceptual drawing illustrating a memory cell threshold voltage distribution change (or migration) related to a read voltage used during a program-verifying operation;

FIG. 7 is a conceptual drawing illustrating memory cell property degradation related to a read voltage used during the program-verifying operation;

FIG. 8 is a conceptual drawing illustrating a memory cell threshold voltage distribution change (or migration) related to both a read voltage and a verifying voltage used during a program-verifying operation;

FIG. 9 is a flowchart summarizing a method of operating a memory controller according to still another embodiment of the inventive concept;

FIG. 10 is a conceptual drawing describing a process wherein garbage collection is performed during the operating method of FIG. 9;

FIGS. 11, 12 and 13 are respective flowcharts summarizing methods of operating a memory controller according to certain embodiments of the inventive concept;

FIG. 14 is a voltage diagram illustrating an exemplary incremental step pulse program(ISPP) voltage signal;

FIGS. 15, 16, 17, 18 and 19 are respective block diagrams illustrating an electronic system including a memory system like the one illustrated in FIG. 1 according to certain embodiments of the inventive concept.

### DETAILED DESCRIPTION OF EMBODIMENTS

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

The term “module” is broadly used in the following written description means a functional or structural combination of hardware capable of performing a particular process or method, or software capable of controlling hardware in an embodiment of the inventive concept. Accordingly, a module may be implemented as a logical unit and/or program code driving one or more hardware/software resource(s). However, the module does not surely mean a code physically connected or one type of hardware.

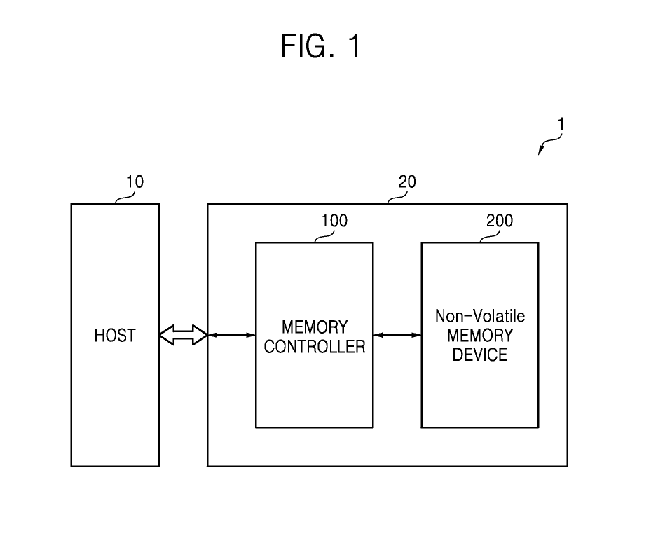

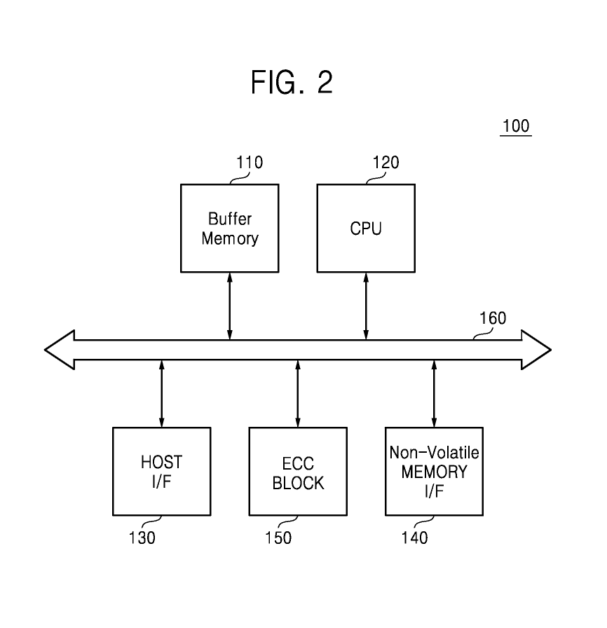

Figure (FIG.) 1 is a block diagram of an electronic system according to an embodiment of the inventive concept, and FIG. 2 is a block diagram further illustrating the memory controller 100 of FIG. 1. Referring to FIG. 1, an electronic system 1 generally comprises a host 10 and a memory system 20.

The memory system 20 is connected to the host 10 and generally includes a memory controller 100 and a non-volatile memory device 200. The memory controller 100 may be used to control information exchanges (i.e., control, address, and/or data information) between the host 10 and non-volatile memory device 200. For example, the memory controller 100 may be used to erase, read, and/or write data in the non-volatile memory device 200 in response to commands and/or control signals received from the host 10. In addition, the memory controller 100 may be used to control certain internal (or housekeeping) operations necessary to the proper and efficient operation of the non-volatile memory device 200. Many different types of these “internal operations” are conventionally understood and include as examples; garbage collection operations, interleaving operations, wear-leveling operations, etc.

The non-volatile memory device 200 may be used to store many different data types, such as programming data, user-defined data, bulk (or payload) data, etc.

In certain embodiments of the inventive concept, the non-volatile memory device 200 will be embodied using one or more flash memory device(s), embedded multimedia card(s) (eMMC), universal flash storage (UFS) unit(s), solid state drive(s) (SSD), redundant array of independent (or inexpensive) disks (RAID), etc. However, other embodiments of the inventive concept may include, additionally or alternatively, one or more non-volatile data storage media that is not based on a flash memory device. Such non-volatile data storage media may include an Electrically Erasable Programmable Read-Only Memory (EEPROM), a Magnetic RAM (MRAM), a Spin-Transfer Torque MRAM, a Conductive bridging RAM (CBRAM), a Ferroelectric RAM (FeRAM), a Phase change RAM (PRAM), a Resistive RAM (RRAM), a Nanotube RRAM, a Polymer RAM (PoRAM), a Nano Floating Gate Memory (NFGM), a holographic memory, a Molecular Electronics Memory Device, or an Insulator Resistance Change Memory.

Referring to FIG. 2, the memory controller 100 comprises in relevant portion a buffer memory 110, a central processing unit (CPU) 120, a host interface 130, a non-volatile memory interface 140, an error correction code (ECC) block 150, and a bus 160. According to certain embodiments, the buffer memory 110 may be embodied using a volatile memory (e.g., a static random access memory (SRAM) or a Dynamic random access memory (DRAM)).

The buffer memory 110 may be used to temporarily store “write data” to be written in the non-volatile memory device 200 during a write (or program) operation, and/or “read data” retrieved from the non-volatile memory device 200 during a read operation. FIG. 2 illustrates an embodiment wherein the buffer memory 110 is internally configured within the memory controller 100. However, in other embodiments a buffer memory external to the memory controller 100 may be configured for use with the memory controller 100.

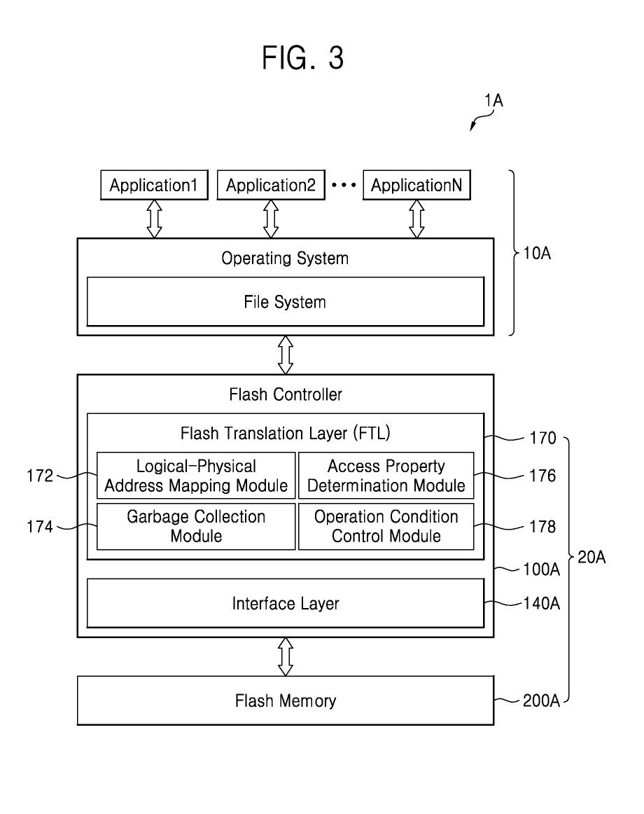

The CPU 120 may be used to control the overall operation of the memory controller 100. That is, the CPU 120 may be used to control information (e.g., data) exchanges between the buffer memory 110, host interface 130, non-volatile memory interface 140, and ECC block 150 using the bus 160. Moreover, the CPU 120 may be used to drive a Flash Translation Layer (FTL) of the non-volatile memory device 200. One example of a FTL will be described with reference to FIG. 3 hereafter.

The host interface 130 may be used to communicate information and data with the host 10 using one of a number of conventionally understood interface protocols. For example, certain embodiments of the inventive concept may use an interface protocol such as the UHS-1 or UHS-II (UHS), a peripheral component interconnect-express(PCI-E), an Advanced Technology Attachment (ATA), a serial ATA (SATA), a parallel ATA (PATA), or a serial attached SCSI (SAS). According to another example embodiment, the interface protocol may be an interface protocol such as a Universal Serial Bus (USB), a multi-media card (MMC), an enhanced small disk interface (ESDI), or an Integrated Drive Electronics (IDE), etc.

The non-volatile memory interface 140 may be used to communicate information and data with the non-volatile memory device 200.

The error correction code (ECC) block 150 may be used to detect and/or correct one or more error(s) included in write data to be stored in the non-volatile memory device 200 or read data retrieved from the non-volatile memory device 200 using one or more of many conventionally understood error correction coding techniques.

In certain embodiments, the memory system 20 may further include a Read Only Memory (ROM) storing programming code used to control certain aspects of the operation of the memory system 20; a clock module used to generate one or more clock signals; and a timer used to temporally measure execution periods during the operation of the memory controller 100. However, these components are conventionally understood by those skilled in the art and are therefore not illustrated in FIG. 2 nor described in any additional detail herein.

FIG. 3 is a block diagram illustrating certain relationships between hardware and software components in the electronic system of FIG. 1. Referring to FIGS. 1 and 3, a host 10A similar to the host 10 of FIG. 1 includes an operating system (OS) and various application programs (e.g., Application 1 to Application N) that operate in conjunction with (i.e., using one or more resources called by) the OS. A flash controller 100A similar to the memory controller 100 of FIG. 1 includes a flash translation layer (FTL) 170 and an interface layer 140A. The interface layer 140A may be understood as comprising all or part of the non-volatile memory interface 140 described in relation to FIG. 2.

The FTL 170 is essentially a specialty software layer that is used to manage the (re)assignment and/or (re)allocation of memory space within a flash memory device 200A similar to the non-volatile memory 200 of FIG. 1. The FTL 170 is functionally disposed between the host 10A and interface layer 140A and in addition to other benefits allows the flash memory device 200A to be used without correction or redefinition of its file system. In its operation, the FTL 170 includes a logical address-to-physical address (logical-physical address) mapping module 172, a garbage collection module 174, an access property determination module 176, and an operation condition control module 178.

Each of the logical-physical address mapping module 172, garbage collection module 174, access property determination module 176, and operation condition control module 178 may be functionally or logically separated from one another, and/or variously provided by hardware, firmware, and/or software.

The logical-physical address mapping module 172 may be used to translate or “map” a logical address related to (i.e., defined by) the file system of the host 10A into a corresponding physical address for the flash memory device 200A. This mapping function may be variously implemented, such as by the use of one or more address mapping table(s).

The garbage collection module 174 may be used to execute a garbage collection operation that creates, deletes, and variously manages valid page(s) for a plurality of memory blocks of the flash memory device 200A. In certain embodiments, a garbage collection operation may be performed by essentially copying the data from all or part of one or more valid page(s) of a working block of the flash memory device 200A into a “new block”, and thereafter erasing the working block to thereby create an available “free block” that may subsequently be assigned as another new block. Thus, the garbage collection operation facilitates the re-allocation of partially full blocks or blocks storing obsolete data into free blocks that may be subsequently used to store incoming write data.

The access property determination module 176 may be used to determine an “access property” associated with a given “address region” of the flash memory device 200A. Exemplary access properties include: frequency of data access; frequency of program access; frequency of erase access; frequency of update access; frequency of read access; etc. In certain embodiments, the access property determination module 176 will store information characterizing one or more access properties for of each address region of the flash memory device 200A. In this manner, the access property determination module 176 may serve as an index that indicates the one or more access properties.

The operation condition control module 178 may be used to control one or more selected operation condition(s) for the flash memory device 200A according to one or more determination results made in relation to the index information provided by the access property determination module 176. For example, the operation condition control module 178 may adjust the level or timing of a “read voltage” applied during a program-verifying operation, the level or timing of a verified voltage applied during the program-verifying operation, the level or timing of a read voltage applied during a read operation, a read refresh condition, the size of a step increase (or step decreases) for a step increment of an incremental step pulse program (ISPP) voltage signal, etc.

The interface layer 140A serves as a flash interface between the memory controller 100A and the flash memory device 200A.

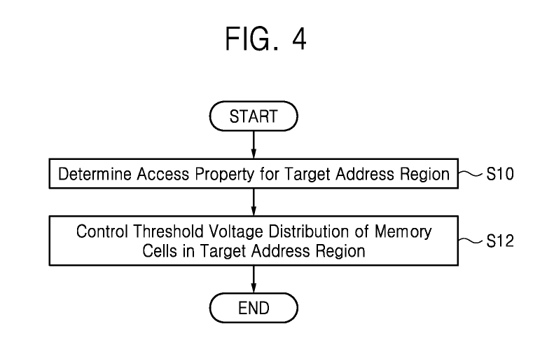

FIG. 4 is a flowchart summarizing a method of operating a memory controller according to certain embodiments of the inventive concept. Referring to FIGS. 3 and 4, the access property determination module 176 may be used to determine an access property for a designated address region of the flash memory device 200A (S10). That is, according to certain embodiments, the access property determination module 176 may be used to store information regarding a plurality of “address regions” (e.g., sections) for the flash memory device 200A. When an “input address” identifying certain read data stored in the flash memory device 200A is received as part of a read operation, for example, the access property determination module 176 may determine which address region the input address resides in, and then look-up (or index) corresponding access property information for the address region.

In this regard, it is possible that only certain data type(s) (i.e., data having one or more type(s) of access properties) may be written into particular address regions. Thus, one or more address regions may be designated to store only data that is frequently updated, or data that is frequently read, etc.

According to certain embodiments of the inventive concept, the access property determination module 176 may therefore be used to monitor the frequency and/or number of various data access types (e.g., program access, erase access, read access, update access, etc.) for each one of a plurality of address regions for the flash memory device 200A. The access property determination module 176 may then determine an access property characteristic or indication from the monitoring results. For example, the access property determination module 176 may include one or more counters capable of counting over a given time period a number of access types. The access information derived by the access property determination module 176 (e.g., counted numbers of various access types) may then be stored, for example, in a particular address region (e.g., a spare or metadata region) of the flash memory device 200A.

Using empirical data characterizing the operative nature of the constituent memory cells of the flash memory device 200A for instance, the access property determination module 176 may derive a “relative access property characteristic” for each monitored access property. Thus, as a simple example, each monitored access frequency type may be designated as being relatively “high” or “low” in relation to an established count number.

With the foregoing access property information derived, stored and characterized, the operation condition control module 178 may then be used to control the threshold voltage distribution of memory cells included in an address region of the flash memory device 200A according to one or more access properties for the memory cells as determined by the access property determination module 176 (S12).

As noted above for certain embodiments, the operation condition control module 178 may adjust one or more operation condition(s) such as a read voltage level/timing; verified voltage level/timing; read refresh; step increment for a ISPP voltage signal; etc.

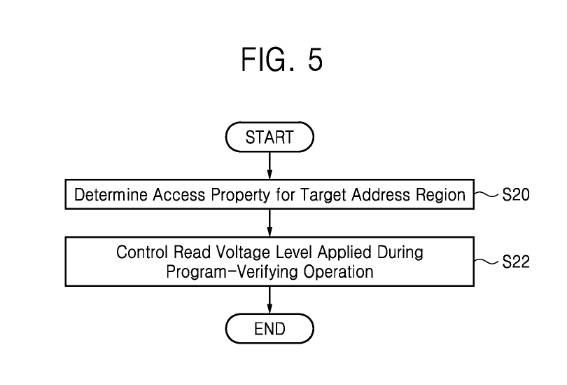

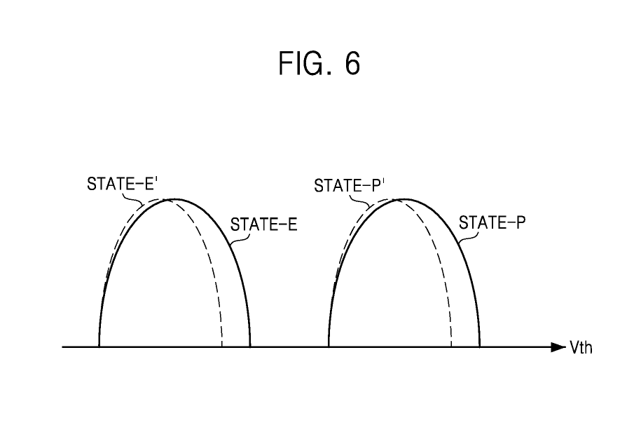

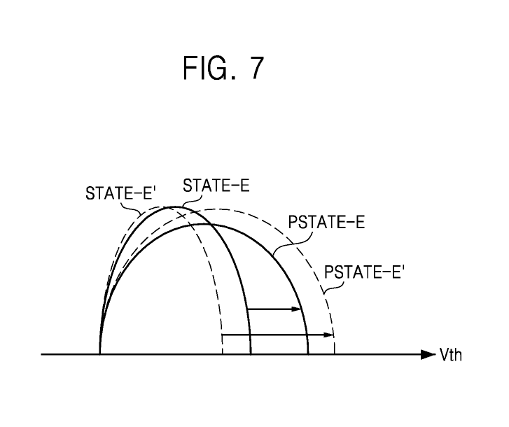

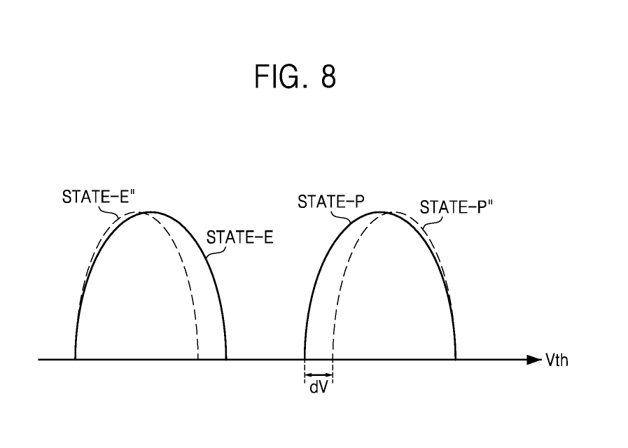

FIG. 5 is another flowchart summarizing a method of operating a memory controller according to an embodiment of the inventive concept. FIG. 6 is a conceptual drawing illustrating a memory cell threshold voltage distribution change (or migration) related to a read voltage used during a program-verifying operation. FIG. 7 is a conceptual drawing illustrating memory cell property degradation related to a read voltage used during the program-verifying operation, and FIG. 8 is a conceptual drawing illustrating a memory cell threshold voltage distribution change (or migration) related to both a read voltage and a verifying voltage used during a program-verifying operation.

Referring collectively to FIGS. 3, 4, 5, 6, 7, and 8, the access property determination module 176 may be used to determine an access property for a “target address region” (i.e. an address region including memory cells identified by an input address) of the flash memory device 200A (S20). Then, the operation condition control module 178 is used to control the level of a read voltage applied to the memory cells during a program-verifying operation based on certain access property information about target address region derived by the access property determination module 176 (S22).

In relation to the foregoing method illustrated in FIG. 5, certain access property information provided by the access property determination module 176 for the target address region may indicate a relatively “high” or “low” (hereafter, “high/low”) number of program and erase (“P/E”)accesses for the constituent memory cells, and the operation condition control module 178 may determine to increase the level of the read voltage applied during program-verifying operations directed to memory cells of the target address region when the number of P/E accesses is deemed to be high. Alternately or additionally, in relation to the foregoing method illustrated in FIG. 5, other access property information provided by the access property determination module 176 for the target address region may indicate a high/low number of read accesses for the constituent memory cells, and the operation condition control module 178 may determine to decrease the level of a read voltage applied during program-verifying operations directed to the constituent memory cells of the target address region.

Referring now to FIG. 6, when increasing the level of the read voltage applied during program-verifying operations, an erase state (STATE-E′) and a program state (STATE-P′) may be improved (i.e., defined with better initial threshold voltage distributions) than an erase state (STATE-E) and a program state (STATE-P) existing before the increase in the level of the read voltage. However, when increasing the level of a program-verifying operation read voltage, a threshold voltage distribution for memory cells having the erase state may be unacceptably degraded following a number of read cycles.

Referring to FIG. 7, a threshold voltage distribution for the erase state (STATE-E) before increasing the level of the read voltage may become degraded (e.g.,) to an erase state like (PSTATE-E) after execution of a number of read cycles. In addition, a threshold voltage distribution of the erase state (STATE-E′) after increasing the level of the read voltage may be degraded (e.g.,) to an erase state (PSATE-E′) after execution of a number of read cycles. Hence, when comparing the illustrated exemplary erase states (PSATE-E) and (PSATE-E′) after execution of a number of read cycles, the threshold voltage distribution after increasing the level of the program-verifying operation read voltage is worse. That is, when the program-verifying operation read voltage is increased, an initially resulting threshold voltage distribution may be acceptable, but this acceptable threshold voltage distribution is lost after only several read cycles.

Thus, when a target address region is characterized by a high P/E access property, the initial threshold voltage distribution has a more significant impact on the reliability of a memory system 100A as compared with the threshold voltage distribution resulting after several read cycles. In this case, the operation condition control module 178 may improve the initial threshold voltage distribution by increasing the level of the read voltage applied during program-verifying operations directed to the target address region. Contrarily, when the target address region is characterized by a high read access property, the threshold voltage distribution resulting from several read cycles has a more significant impact on the reliability of the memory system 100A. Therefore, the operation condition control module 178 may improve the threshold voltage distribution resulting from the several read cycles by decreasing the level of the read voltage applied during program-verifying operations directed to the target address region.

FIG. 8 is a conceptual diagram illustrating a threshold voltage distribution at the time when a verified voltage applied during the program-verifying operation is additionally increased. Thus, as the operation condition control module 178 increases the respective levels of the verified voltage and the read voltage applied during the program-verify operation, the threshold voltage distribution of the erase state (STATE-E) and the program state (STATE-P) may be improved into the erase state (STATE-E″) and the program state (STATE-P″). That is, as the level of the verified voltage is increased, the threshold voltage distribution for the program state STATE-P″ will be shifted by as much as an increased magnitude “dV” as compared with when the lower level verified voltage previous provide the threshold voltage distribution of the program state (STATE-P).

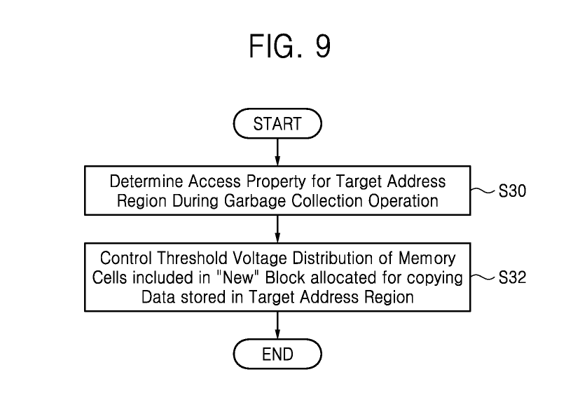

FIG. 9 is another flowchart summarizing a method of operating a memory controller according to still another embodiment of the inventive concept. Referring to FIGS. 3 and 9, the access property determination module 176 may receive an input address identifying a target address region which is the object of a garbage collection operation, as executed under the control of the garbage collection module 174. In response, the access property determination module 176 may obtain access property information for the target address region as well as information indicating the valid/invalid nature of the data stored in the target address region which is the object of the garbage collection operation. Relevant address information is also provided by the garbage collection module 174.

With this information, the access property determination module 176 is able to determine access property information for the target address region (S30). In certain embodiments of the inventive concept, access property information for the target address region may be determined only if the data in the target address region is deemed valid. Then, the operation condition control module 178 may control the threshold voltage distribution of memory cells included in a “new block” to which data previously stored in the target address region is copied, wherein said control of the threshold voltage distribution is performed in relation to the access property information determined by the access property determination module 176 (S32).

The nature of the foregoing “control” may be understood by consideration of the foregoing examples drawn to a high/low P/E access property and/or a high/low read access property, and the level of a read voltage applied during program-verifying operations to the memory cell of the new block, and/or the level of a read voltage applied during read operations.

According to another embodiment, the operation condition control module 178 may compare an erase count value indicating a number of erase operation previously performed on the memory cells of the new block with a reference value. Thus, when the target address region has high read access property, the operation condition control module 178 may decrease the level of the read voltage applied during program-verifying operations directed to the new block, but only if the erase count value remains less than the reference value. When the erase count value for the memory cell of the new block exceeds the reference value, and even if the target address region has a high read access property, the level of the read voltage applied during program-verifying operation directed to the new block will be maintained at a default value, and not increased.

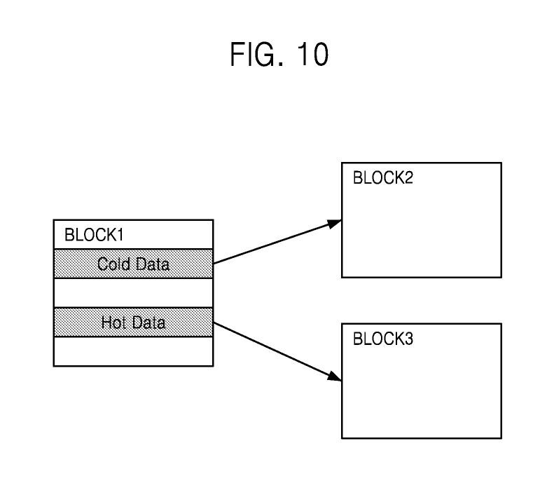

FIG. 10 is a conceptual drawing illustrating a process wherein garbage collection operation may be performed according to the method of FIG. 9. Referring to FIGS. 9 and 10, a first block BLOCK1 is assumed to be an existing block that is the object of the garbage collection operation. A second block BLOCK2 and a third block BLOCK3 are “new blocks” allocated for copying data presently stored in valid page(s) of the first block BLOCK1 as the garbage collection operation begins.

Data designated by one or more access properties as “Hot Data” is assumed to be stored in one portion of the first block BLOCK1. Other data designated as “Cold Data” is also stored in another portion of the first block BLOCK1. According to these particular data type designations may in relation to various access properties, the Cold Data may be copied to the second block BLOCK2 while and the Hot D may be copied to the third block BLOCK3. Thereafter, the operation condition control module 178 may decrease the level of a read voltage applied during program-verifying operations directed to the memory cells of the second block BLOCK2 while increasing the level of a read voltage applied during program-verifying operations directed to the memory cells of the third block BLOCK3.

According to an example embodiment, the operation condition control module 178 may select a block to be allocated for copying data among a plurality of blocks each having a differently set read voltage used in performing the program-verifying operation according to an access property determined by the access property determination module 176.

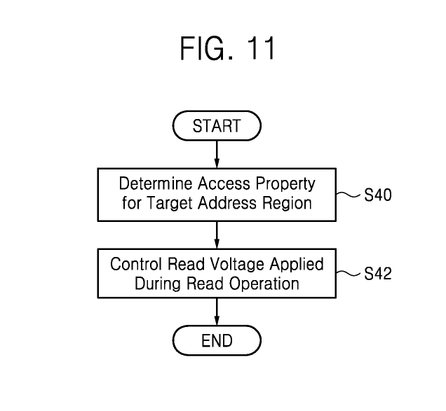

FIG. 11 is a flowchart summarizing a method of operating a memory controller according to still another embodiment of the inventive concept. Referring to FIG. 11, the access property determination module 176 may be used to determine an access property for a target address region of the flash memory device 200A (S40). Then the operation condition control module 178 may be used to control the level of a read voltage applied during a read operation directed to memory cells of the target address region (S42). Thus, when a read voltage applied during program-verifying operations is changed in response to certain access property information regarding the target address region, the operation condition control module 178 may be further used to control the level of the read voltage applied during read operations to be equal to the level of the read voltage applied during program-verifying operations.

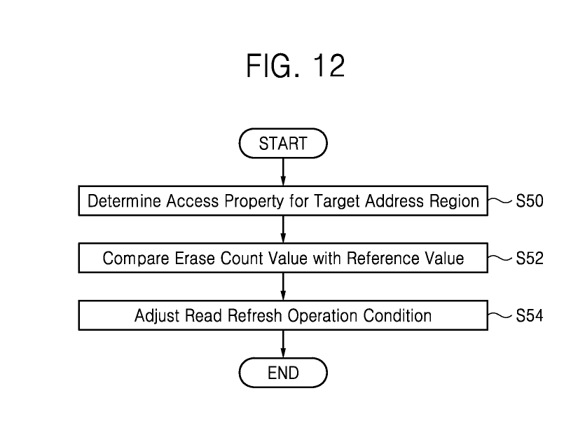

FIG. 12 is another flowchart summarizing a method of operating a memory controller according to still another embodiment of the inventive concept. Referring to FIGS. 3 and 12, the access property determination module 176 may be used to determine an access property for a target address region of the flash memory device 200A (S50). Then, the operation condition control module 178 may be used to compare an erase count value for at least one block of the target address region with a reference value (S52), and adjust a read refresh operation condition for the target address region based on the access property and the comparison result (S54).

According to certain embodiments, when the target address region is characterized by a high P/E access property, the operation condition control module 178 may decrease a read count value which is used as a reference controlling the read refresh operation condition for the target address region. Contrarily, when the target address region is characterized by a high read access property, the operation condition control module 178 may increase the read count value. Thus, when an erase count value for a counted block of the target address region is greater than the reference value, the operation condition control module 178 may decrease the read count value that is used as a reference for the read refresh operation condition of the target address region. Contrarily, when the erase count value of the counted block is less than the reference value, the operation condition control module 178 may increase the read count value.

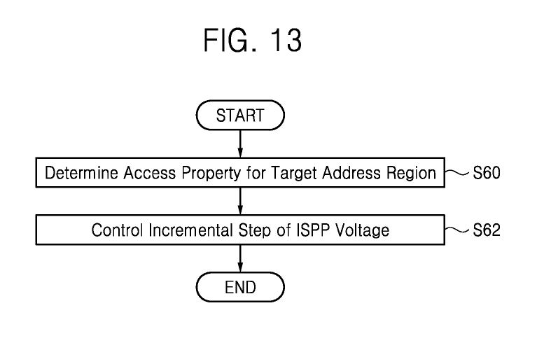

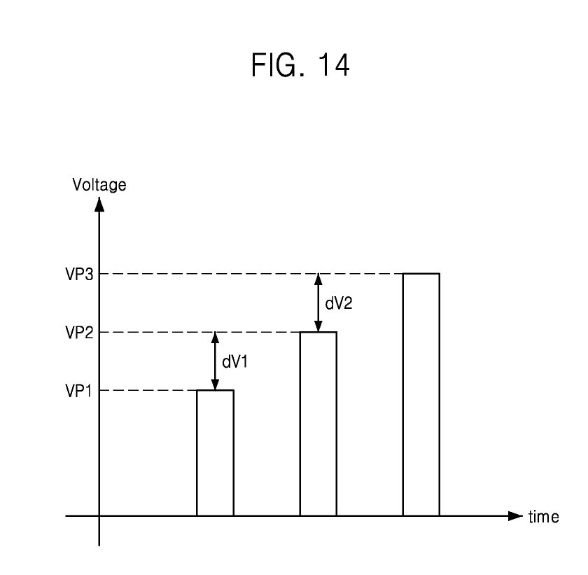

FIG. 13 is a flowchart summarizing a method of operating a memory controller according to still another embodiment of the inventive concept, and FIG. 14 is a drawing illustrating an adjustable, incremental step increase for an incremental step pulse program (ISPP) voltage.

Referring to FIGS. 3, 13 and 14, the access property determination module 176 may be used to determine an access property for a target address region of the flash memory device 200A (S60). Then, in order to more accurately control the threshold voltage distribution of memory cells in the flash memory device 200A, an incremental step pulse program (ISPP) method may be used. As will be generally understood by those skilled in the art, ISPP methods adjust (i.e., increase) the level of a program voltage step-by-step over a sequence of program loops (S62). Here, a level for the incremental step increase of the ISPP voltage may be stepped from a first voltage VP1 used during a first program loop to a higher (by an amount “dV1”) second voltage VP2 used during a second program loop, and then to an even higher (buy an additional “dV2”) third voltage VP3 used during a third program loop. In the context of certain embodiments of the inventive concept, the actual amount of the incremental step applied to the ISSP for a given program loop may be varied by the operation condition control module 178 according to certain access property information provided by the access property determination module 176 in relation to the target address region (S62).

According to the increased amount dV1 or dV2 of the ISPP voltage signal, an initial threshold voltage distribution of a programmed memory cell may be changed. For example, when the increased amount dV1 or dV2 of the ISPP voltage signal is increased, the initial threshold voltage distribution of the programmed memory cell may become poor. Contrarily, when the increased amount dV1 or dV2 of the ISPP voltage signal is decreased, the initial threshold voltage distribution of the programmed memory cell may become good.

According to an example embodiment, when an address region has an access property of the first type having the large number of program accesses and erase accesses, the operation condition control module 178 may decrease the increased amount dV1 or dV2 of the ISPP voltage signal used in performing the program-verifying operation on the address region. Contrarily, when the address region has an access property of the second type having the large number of read accesses, the operation condition control module 178 may increase the increased amount dV1 or dV2 of the ISPP voltage signal used in performing the program-verifying operation on the address region.

According to another example embodiment, the operation condition control module 178 may control a program start voltage, e.g., a first voltage VP1, used in performing the program-verifying operation on the specific address region of the flash memory device 200A according to a determination result of the property determination module 176.

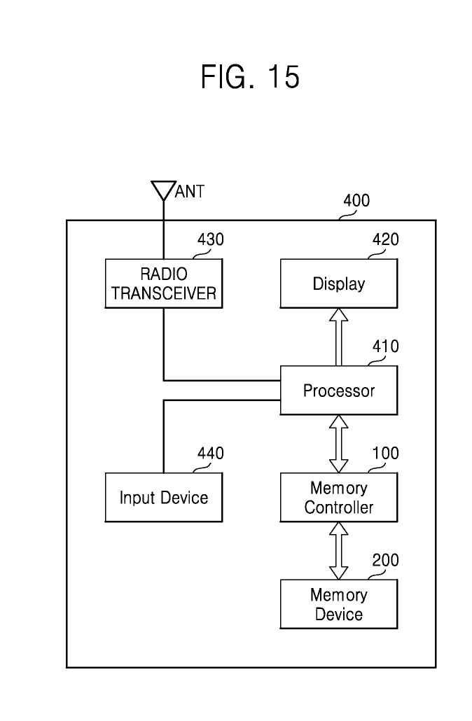

FIG. 15 is a block diagram according to an example embodiment of an electronic system including the memory system illustrated in FIG. 1. Referring to FIGS. 1 and 15, an electronic system 400 may be embodied in a cellular phone, a smart phone, a personal digital assistant (PDA), or a radio communication device.

The electronic system 400 may include a non-volatile memory device 200, a memory controller 100 which may control an operation of the non-volatile memory device 200, a processor 410, a display 420, a radio transceiver 430, and an input device 440. The memory controller 100 may control a data access operation of the non-volatile memory device 200, e.g., a program operation, an erase operation, or a read operation, according to a control of the processor 410.

Data programmed in the non-volatile memory device 200 may be displayed through the display 420 according to the processor 410 and/or a control of the memory controller 100. The processor 410 may control an operation of the display 420 so that data output from the memory controller 100, data output from the radio transceiver 430, or data output from the input device 440 may be displayed through the display 420.

The radio transceiver 430 may transmit or receive a radio signal through an antenna ANT. For example, the radio transceiver 430 may convert a radio signal received through the antenna ANT to a signal which may be processed by the processor 410. Accordingly, the processor 410 may process a signal output from the radio transceiver 430, and transmit the processed signal to the memory controller 100 or the display 420.

In addition, the radio transceiver 430 may change a signal output from the processor 410 into a radio signal, and output the changed radio signal to an external device through the antenna ANT.

The input device 440 may be embodied in a pointing device such as a touch pad and a computer mouse, a keypad, or a keyboard as a device which may input a control signal for controlling an operation of the processor 410 or data to be processed by the processor 410. According to an example embodiment, the memory controller 100 which may control an operation of the non-volatile memory device 200 may be embodied in a portion of the processor 410 or an additional chip of the processor 410.

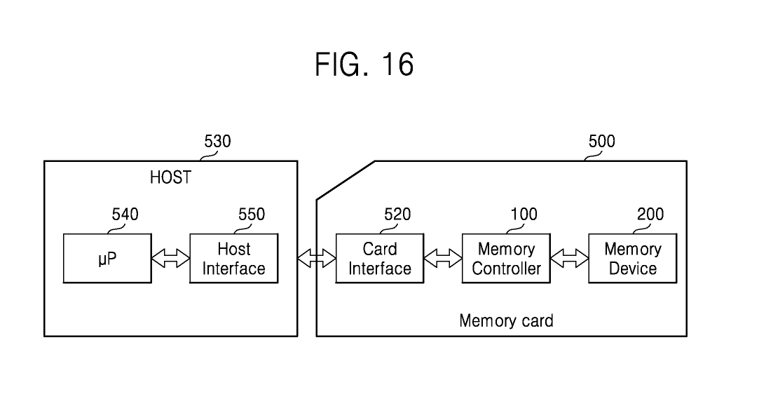

FIG. 16 is a block diagram according to another example embodiment of the electronic system including the memory system illustrated in FIG. 1. Referring to FIGS. 1 and 16, an electronic system 500 may be embodied in a memory card or a smart card.

The electronic system 500 includes the memory controller 100, the non-volatile memory device 200, and a card interface 520. The memory controller 100 may control a data exchange between the non-volatile memory device 200 and the card interface 520.

The card interface 520 may interface a data exchange between the host 530 and the memory controller 100 according to a protocol of the host 530. According to an example embodiment, the card interface 520 may be a secure digital (SD) card interface or a multi-media card(MMC) interface; however, the card interface is not limited thereto.

According to another example embodiment, the card interface 520 may support a Universal Serial Bus (USB) protocol, an InterChip (IC)-USB protocol. Here, ‘a card interface’ herein may mean hardware which may support a protocol used by the host 530, software equipped in the hardware, or a signal transmission method. The host 530 may be embodied in a PC, a tablet PC, a digital camera, a digital audio player, a mobile phone, console video game hardware, or a digital set-top box.

When the electronic system 500 is connected to a host interface 550 of the host 530, the host interface 550 may perform a data communication with the non-volatile memory device 200 through the card interface 520 and the memory controller 100 according to a control of a microprocessor 540.

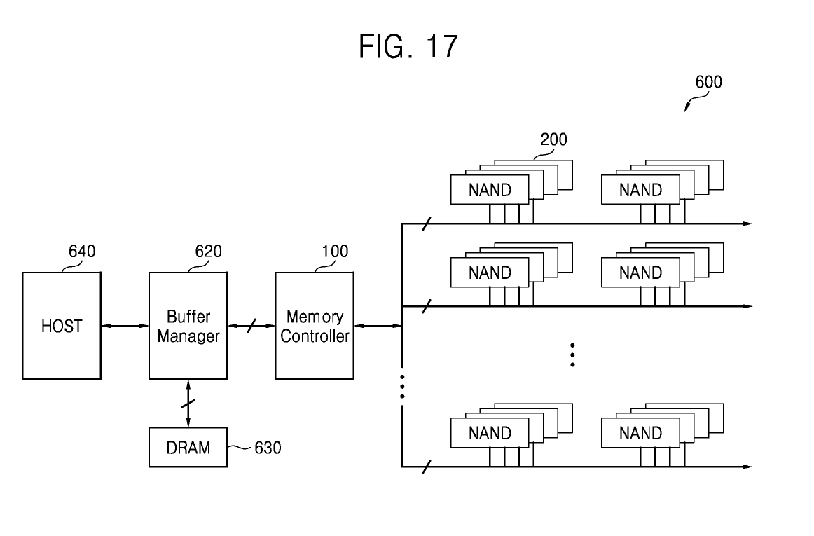

FIG. 17 is a block diagram according to still another example embodiment of the electronic system including the memory system illustrated in FIG. 1. Referring to FIGS. 1 and 17, an electronic system 600 may be embodied in a solid state drive (SSD).

The electronic system 600 may include the memory controller 100, a plurality of non-volatile memory devices 200, a buffer manager 620, a volatile memory device 630, and a host 640. The memory controller 100 may control a data processing operation of each of the plurality of non-volatile memory devices 200.

The buffer manager 620 may control storage of data transmitted or received between the memory controller 100 and the host 640 in the volatile memory device 630. The volatile memory device 630 may buffer data transmitted or received between the memory controller 100 and the host 640. According to an example embodiment, the volatile memory device 630 may be embodied in a dynamic random access memory (DRAM).

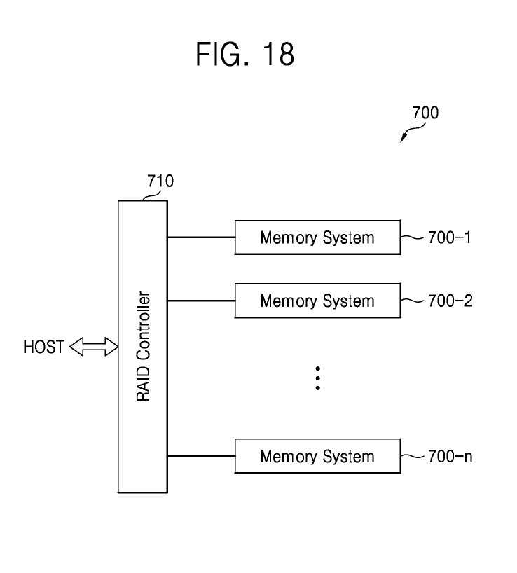

FIG. 18 is a block diagram according to still another example embodiment of the electronic system including the memory system illustrated in FIG. 1. Referring to FIGS. 1 and 18, a data processing system 700 which may be embodied in a redundant array of independent disks (RAID) system may include a RAID controller 710 and a plurality of memory systems 700-1 to 700-n, where n is a natural number.

Each of the plurality of memory systems 700-1 to 700-n may be the memory system 20 illustrated in FIG. 1. The plurality of memory systems 700-1 to 700-n may configure a RAID array. According to an example embodiment, the data processing device 700 may be embodied in a personal computer (PC) or a SSD.

While performing a program operation, the RAID controller 710 may transmit program data output from a host according to a program instruction output from the host to at least one of the plurality of memory systems 700-1 to 700-n according to a RAID level. While performing a read operation, the RAID controller 710 may transmit data which are read from at least one of the plurality of memory systems 700-1 to 700-n according to a read instruction output from the host. The host of FIG. 18 may mean the host 10 of FIG. 1.

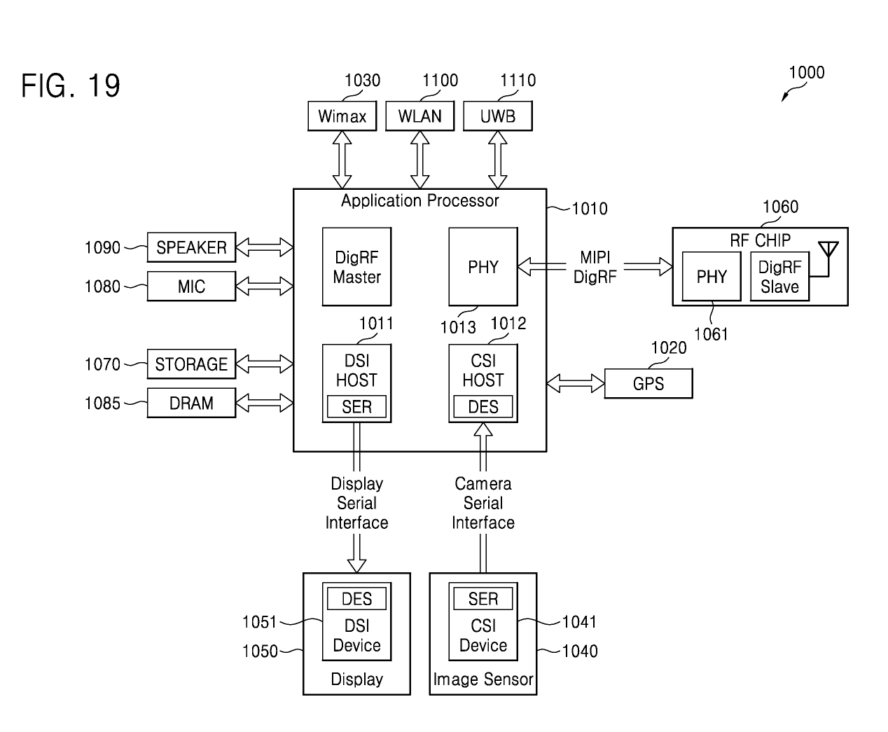

FIG. 19 is a block diagram of the electronic system according to an example embodiment of the present inventive concepts. Referring to FIGS. 1 and 19, an electronic system 1 of FIG. 1 may be embodied in an electronic system 1000 of FIG. 19. The electronic system 1000 may be embodied in a data processing device which may use or support a mobile industry processor interface (MIPI®), e.g., personal digital assistants (PDA), a portable multimedia player(PMP), an internet protocol television(IPTV), or a smart phone.

A camera serial interface (CSI) host 1012 embodied in an application processor 1010 may perform a serial communication with a CSI device 1041 of an image sensor 1040 through a camera serial interface. Here, for example, the CSI host 1012 may include a deserializer (DES), and the CSI device 1041 may include a serializer (SER).

A DSI host 1011 embodied in the application processor 1010 may perform a serial communication with a DSI device 1051 of the display 1050 through a display serial interface(DSI). Here, for example, the DSI host 1011 may include a serializer (SER), and the DSI device 1051 may include a deserializer (DES). According to an example embodiment, the electronic system 1000 may further include a RF chip 1060 which may communicate with the application processor 1010. A PHYsical layer (PHY) 1013 included in the application processor 1010 and a PHY 1061 included in the RF chip 1060 may transmit or receive data each other according to MIPI DigRF.

According to an example embodiment, the electronic system 1000 may further include a GPS 1020 receiver, a storage 1070, a microphone (MIC) 1080, a dynamic random access memory (DRAM) 1085, and a speaker 1090. The host 10 of FIG. 1 may be embodied in a storage 1070 of FIG. 19.

The electronic system 1000 may perform a communication using a world interoperability for microwave access (Wimax) module 1030, a wireless lan (WLAN) module 1100, and/or a ultra wideband (UWB) module 1110.

A method and a device according to an example embodiment of the present inventive concepts may improve reliability of a memory device by controlling a threshold voltage distribution of memory cells included in the address region according to an access property and forming an optimal threshold voltage distribution in each application.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of operating a memory controller, comprising:
determining an access property for a target address region of a nonvolatile memory device; and
controlling a threshold voltage distribution of memory cells in the target address region in accordance with the determined access property.

2. The method of claim 1, wherein the access property includes a high/low program and erase (P/E) access property and high/low read access property.

3. The method of claim 2, wherein the controlling of the threshold voltage distribution of the memory cells includes controlling a level of a read voltage applied during program-verifying operations (program-verifying read voltage).

4. The method of claim 3, wherein upon determining a high P/E access property for the target address region, increasing the program-verifying read voltage, and
upon determining a high read access property for the target address region, decreasing the program-verifying read voltage.

5. The method of claim 3, wherein the controlling of the threshold voltage distribution of the memory cells further includes controlling a level of a verified voltage applied during the program-verifying operations (program-verifying verified voltage).

6. The method of claim 5, wherein upon determining a high P/E access property for the target address region, increasing the program-verifying verified voltage, and
upon determining a high read access property for the target address region, decreasing the program-verifying verified voltage.

7. The method of claim 1, wherein the determining of the access property comprises:
receiving an input address identifying memory cells; and thereafter,
determining the target address region including the identified memory cells, wherein the nonvolatile memory device is divided into a plurality of address regions.

8. The method of claim 1, wherein the determining of the access property comprises:
before receiving the input address, monitoring a number of accesses related to the access property for memory cells in the target address section;
deriving access property information from the number of accesses; and
indexing the access property information for the target address region.

9. The method of claim 1, wherein the target address region is an object of a garbage collection operation, and the method further comprises:
controlling a threshold voltage distribution for memory cells in a new block allocated for copying data stored in the target address region.

10. The method of claim 9, further comprising:
determining an erase count value for the memory cells of the new block.

11. The method of claim 1, further comprising:
adjusting a read refresh condition in accordance with the determined access property.

12. The method of claim 1, wherein the controlling of the threshold voltage distribution comprises controlling a size of an incremental step increase of an incremental step pulse program (ISPP) voltage in accordance with the determined access property.

13. A memory controller comprising:
an access property determination module that determines an access property for a target address region of a nonvolatile memory device; and
an operation condition control module that controls a threshold voltage distribution of memory cells in the target address region in accordance with the determined access property.

14. The memory controller of claim 13, wherein the access property includes a high/low program and erase (P/E) access property and high/low read access property.

15. The memory controller of claim 14, wherein the operation condition control module controls the threshold voltage distribution of the memory cells by controlling a level of a read voltage applied during program-verifying operations (program-verifying read voltage).

16. The memory controller of claim 15, wherein upon determining a high P/E access property for the target address region, the operation condition control module increases the program-verifying read voltage, and
upon determining a high read access property for the target address region, the operation condition control module decreases the program-verifying read voltage.

17. The memory controller of claim 15, wherein the operation condition control module controls the threshold voltage distribution of the memory cells by further controlling a level of a verified voltage applied during the program-verifying operations (program-verifying verified voltage).

18. The memory controller of claim 17, wherein upon determining a high P/E access property for the target address region, the operation condition control module increases the program-verifying verified voltage, and
upon determining a high read access property for the target address region, the operation condition control module decreases the program-verifying verified voltage.

19. A memory system comprising:
the memory controller of claim 13; and
a nonvolatile memory device including the memory cells.

20. The memory system of claim 19, wherein the nonvolatile memory device is a flash memory device.
